(19) United States
(12) Patent Application Publication
(10) Pub. No.: US 2026/0367837 A1
(43) Pub. Date: Nov. 19, 2026

(54) CLOCK TRAINING FOR MULTIPLEXOR CIRCUITRY

(71) Applicant: Micron Technology, Inc., Boise, ID (US)

(72) Inventors: Boon Hor Lam, Boise, ID (US); Andrey V. Panchenko, Boise, ID (US); Matthew McCarthy, Boise, ID (US); Gang Zhao, Boise, ID (US); William James Pentecost, Boise, ID (US)

(21) Appl. No.: 19/673,437

(22) Filed: May 11, 2026

Related U.S. Application Data
(60) Provisional application No. 63/807,310, filed on May 16, 2025.

(51) Int. Cl. G06F 3/06

(52) U.S. Cl. CPC G06F 3/0659; G06F 3/0604; G06F 3/0653; G06F 3/0679

(57) ABSTRACT

MUX circuitry can enter a test mode by deactivating a MUX and activating a loopback circuitry. The MUX circuitry can receive a different plurality of CA signals. The MUX circuitry can, responsive to entering the test mode, provide the different plurality of CA signals to a testing system implemented external to the memory system using the loopback circuitry. The MUX circuitry can receive a plurality of timing constraints from the testing system, wherein the plurality of timing constraints is based on the different plurality of CA signals provided to the testing system and wherein the plurality of timing constraints modify a timing of a plurality of clock signals when the circuitry is in a mission mode.

### PRIORITY INFORMATION

This application claims the benefits of U.S. Provisional Application No. 63/807,310, filed on May 16, 2025, the contents of which are incorporated herein by reference.

### TECHNICAL FIELD

Embodiments of the disclosure relate generally to memory systems, and more specifically, relate to performing clock training for multiplexor circuitry.

### BACKGROUND

A memory system can include one or more memory devices that store data. The memory devices can be, for example, non-volatile memory devices and volatile memory devices. In general, a host system can utilize a memory system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory system in accordance with some embodiments of the present disclosure.

FIG. 2 is a timing diagram of a number of clock phase passing windows in accordance with some embodiments of the present disclosure.

FIG. 3 is a block diagram corresponding to multiplexor circuitry in accordance with some embodiments of the present disclosure.

FIG. 4 is a block diagram corresponding to multiplexor circuitry in accordance with some embodiments of the present disclosure.

FIG. 5 is a block diagram corresponding to fuse values in accordance with some embodiments of the present disclosure.

FIG. 6 is a flow diagram corresponding to a method for performing clock training for multiplexor circuitry in accordance with some embodiments of the present disclosure.

FIG. 7 is a block diagram of an example computer system in which embodiments of the present disclosure may operate.

### DETAILED DESCRIPTION

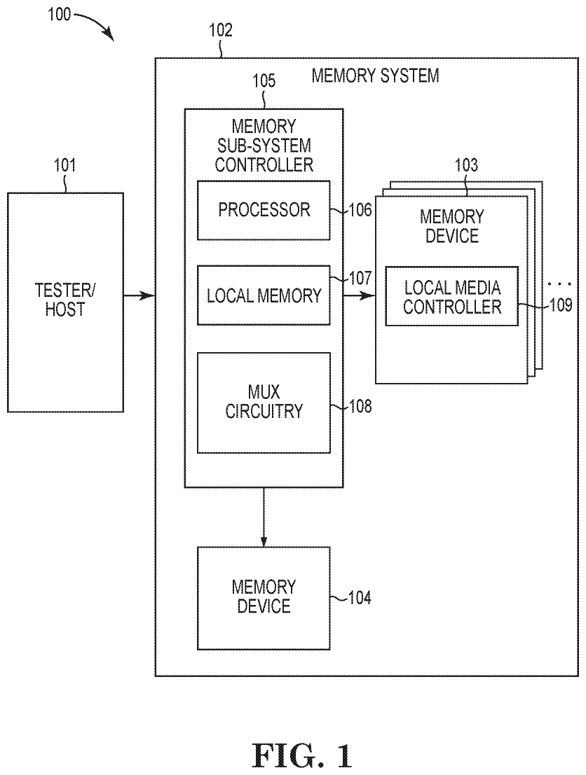

Aspects of the present disclosure are directed to performing clock training, in particular to performing clock training for multiplexor (MUX) circuitry. A memory system can be a storage system, storage device, a memory module, or a combination of such. An example of a memory system is a storage system such as a solid-state drive (SSD). Examples of storage devices and memory modules are described below in conjunction with FIG. 1, et alibi. In general, a host system can utilize a memory system that includes one or more components, such as memory devices that store data. The host system can provide data to be stored at the memory system and can request data to be retrieved from the memory system. The memory system can also undergo in manufacturing testing to train the interaction between clock address (CA) signals and clock signals received by the memory system. The training of the interaction between the CA signals and the clock signals can be referred to as CLK-to-CA training.

In previous examples, a computing system and/or a memory system can comprise a numberer of clock domains. As used herein, a clock domain describes hardware that operates under a specific clock signal. In various examples, a clock signal and/or the hardware that receives the clock signal can be referred to as a clock domain. Synchronous elements, such as flip-flops, random access memory (RAM), and/or shift registers, among other elements, can be considered part of a clock domain. The different clock domains can be asynchronous or synchronous clock domains. Asynchronous clock domains describe clock domains that do not have a known phase or frequency relationship. Synchronous clock domains describe clock domains that are synchronous with a specific clock signal. Synchronous clock domains can have a known phase or frequency relationship and are often generated from a common clock source.

During mission mode function and/or during testing, multi-rank low-power double-data rate memory (LPDRAM) packages with MUX circuitry have reduced clock phase passing windows. The clock phase passing windows can be reduced because a host and/or tester can perform command address-clock (CA-CLK) training on the memory devices (e.g., DRAM) but not on the MUX circuitry that distributes data from the host to the memory devices.

In a multi-rank (LPDRAM) system, the host can perform CA-CLK training for each rank of memory devices. A common clock phase passing window can be found. As used herein, a clock phase passing window describes a duration of time (e.g., window) for which command and address (CA) signals can be received/latched/stored using one or more clock signals. An optimal clock phase for a plurality of memory devices having different clock domains can be the center (e.g., middle) of a clock phase passing window of the common clock phase passing windows of the different memory devices. The optimal clock phase passing window of a plurality of memory devices may be asynchronous with a clock phase passing window of the MUX circuitry or may be misaligned with the clock phase passing window of the MUX circuitry such that errors may be encountered in providing data from the host to the memory devices.

Aspects of the present disclosure address the above and other deficiencies by performing clock training for MUX circuitry. Clock training for the MUX circuitry can include determining a clock phase passing window for the MUX circuitry during manufacturing testing. The clock phase passing window for the MUX circuitry can be used to modify a timing of the MUX circuitry to coincide with the clock phase passing window of the memory devices (e.g., optimal clock phase passing window of the memory devices). Modifying the timing of the MUX circuitry can allow for data to be successfully routed to the memory devices.

FIG. 1 illustrates an example computing system 100 that includes a memory system 102 in accordance with some embodiments of the present disclosure. The memory system 102 can include media, such as one or more volatile memory devices (e.g., memory device 104), one or more non-volatile memory devices (e.g., memory device 103), or a combination of such.

A memory system 102 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, server, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a tester/host system 101 that is coupled to one or more memory systems 102. As used herein, the tester/host system 101 can be referred to as a tester system 101 or a host system 101. The tester/host system 101 describes hardware that can be a tester system 101 or a host system 101 based on the needs of the computing system 101. The tester system 101 can be utilized when the MUX circuitry 108 is in a test mode. The host system 101 can be utilized when the MUX circuitry 108 is in a mission mode.

In some embodiments, the host system 101 is coupled to different types of memory system 102. FIG. 1 illustrates one example of a host system 101 coupled to one memory system 102. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 101 can include a processor chipset and a software stack executed by the processor chipset. The processor chipset can include one or more cores, one or more caches, a memory controller (e.g., an SSD controller), and a storage protocol controller (e.g., PCIe controller, SATA controller). The host system 101 uses the memory system 102, for example, to write data to the memory system 102 and read data from the memory system 102.

The host system 101 and/or the test system 101 can be coupled to the memory system 102 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 101 and/or the test system 101 and the memory system 102. The host system 101 and/or the test system 101 can further utilize an NVM Express (NVMe) interface to access components (e.g., memory devices 103) when the memory system 102 is coupled with the host system 101 and/or the test system 101 by the PCIe interface. The physical host interface can provide an interface for passing control, address, data, and other signals between the memory system 102 and the host system 101 and/or the test system 101. FIG. 1 illustrates a memory system 102 as an example. In general, the host system 101 can access multiple memory systems via a same communication connection, multiple separate communication connections, and/or a combination of communication connections.

The memory devices 103, 104 can include any combination of the different types of non-volatile memory devices and/or volatile memory devices. The volatile memory devices (e.g., memory device 104) can be, but are not limited to, random access memory (RAM), such as dynamic random-access memory (DRAM) and synchronous dynamic random access memory (SDRAM).

Some examples of non-volatile memory devices (e.g., memory device 103) include negative-and (NAND) type flash memory and write-in-place memory, such as three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103, 104 can include one or more arrays of memory cells. One type of memory cell, for example, includes single level cells (SLC) which can store one bit per cell. Other types of memory cells, such as multi-level cells (MLCs), triple level cells (TLCs), quad-level cells (QLCs), and penta-level cells (PLC), can store multiple bits per cell. In some embodiments, each of the memory devices 103 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory devices 103 can be grouped as pages that can refer to a logical unit of the memory device used to store data. With some types of memory (e.g., NAND), pages can be grouped to form blocks.

Although non-volatile memory components such as three-dimensional cross-point arrays of non-volatile memory cells and NAND type memory (e.g., 2D NAND, 3D NAND) are described, the memory device 103 can be based on any other type of non-volatile memory or storage device, such as such as, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

The memory system controller 105 (or controller 105 for simplicity) can communicate with the memory devices 103 to perform operations such as reading data, writing data, or erasing data at the memory devices 103 and other such operations. The memory system controller 105 can include hardware such as one or more integrated circuits and/or discrete components, a buffer memory, or a combination thereof. The hardware can include digital circuitry with dedicated (i.e., hard-coded) logic to perform the operations described herein. The memory system controller 105 can be a microcontroller, special purpose logic circuitry (e.g., a field programmable gate array (FPGA), an application specific integrated circuit (ASIC), etc.), or other suitable processor.

The memory system controller 105 can include a processor 106 (e.g., a processing device) configured to execute instructions stored in a local memory 107. In the illustrated example, the local memory 107 of the memory system controller 105 includes an embedded memory configured to store instructions for performing various processes, operations, logic flows, and routines that control operation of the memory system 102, including handling communications between the memory system 102 and the host system 101 and/or the test system 101.

In some embodiments, the local memory 107 can include memory registers storing memory pointers, fetched data, etc. The local memory 107 can also include read-only memory (ROM) for storing micro-code. While the example memory system 102 in FIG. 1 has been illustrated as including the memory system controller 105, in another embodiment of the present disclosure, a memory system 102 does not include a memory system controller 105, and can instead rely upon external control (e.g., provided by an external host, or by a processor or controller separate from the memory system).

In general, the memory system controller 105 can receive commands or operations from the host system 101 and/or the test system 101 and can convert the commands or operations into instructions or appropriate commands to achieve the desired access to the memory device 103 and/or the memory device 104. The memory system controller 105 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address, physical media locations, etc.) that are associated with the memory devices 103. The memory system controller 105 can further include host interface circuitry to communicate with the host system 101 via the physical host interface. The host interface circuitry can convert the commands received from the host system into command instructions to access the memory device 103 and/or the memory device 104 as well as convert responses associated with the memory device 103 and/or the memory device 104 into information for the host system 101 and/or the test system 101.

The memory system 102 can also include additional circuitry or components that are not illustrated. In some embodiments, the memory system 102 can include a cache or buffer (e.g., DRAM) and address circuitry (e.g., a row decoder and a column decoder) that can receive an address from the memory system controller 105 and decode the address to access the memory device 103 and/or the memory device 104.

In some embodiments, the memory device 103 includes local media controllers 109 that operate in conjunction with memory system controller 105 to execute operations on one or more memory cells of the memory devices 103. An external controller (e.g., memory system controller 105) can externally manage the memory device 103 (e.g., perform media management operations on the memory device 103). In some embodiments, a memory device 103 is a managed memory device, which is a raw memory device combined with a local controller (e.g., local controller 109) for media management within the same memory device package. An example of a managed memory device is a managed NAND (MNAND) device.

The memory system 102 can include MUX circuitry 108. Although not shown in FIG. 1 so as to not obfuscate the drawings, the MUX circuitry 108 can include various circuitry to facilitate configuring the pulse leakage (e.g., clock pulse leakage). In some embodiments, the MUX circuitry 108 can include special purpose circuitry in the form of an ASIC, FPGA, state machine, and/or other logic circuitry that can allow the MUX circuitry 108 to orchestrate and/or perform operations to described herein.

In some embodiments, the memory system controller 105 includes at least a portion of the MUX circuitry 108. For example, the memory system controller 105 can include a processor 106 (processing device) configured to execute instructions stored in local memory 107 for performing the operations described herein. In some embodiments, the MUX circuitry 108 can be implemented externally to the memory system controller 105 but internal to the memory system 102.

In a non-limiting example, an apparatus (e.g., the computing system 100) can include the MUX circuitry 108. The MUX circuitry 108 can be resident on the memory system 102. As used herein, the term “resident on” refers to something that is physically located on a particular component. For example, the MUX circuitry 108 being “resident on” the memory system 102 refers to a condition in which the hardware circuitry that comprises the MUX circuitry 108 is physically located on the memory system 102. The term “resident on” can be used interchangeably with other terms such as “deployed on” or “located on,” herein.

In various examples, the MUX circuitry 108 can be configured to route received data signals to the memory devices 103, 104. To correctly route data signals from the MUX circuitry 108 to the memory devices 103, 104, the MUX circuitry can be tested to determine an optimal clock phase passing window for the MUX circuitry. The MUX circuitry's optimal clock phase passing window can be used to modify a timing of clock signals provided to the MUX circuitry. The modification of the clock signals provided to the MUX circuitry can allow for data to correctly be provided from the MUX circuitry to the memory devices 103, 104.

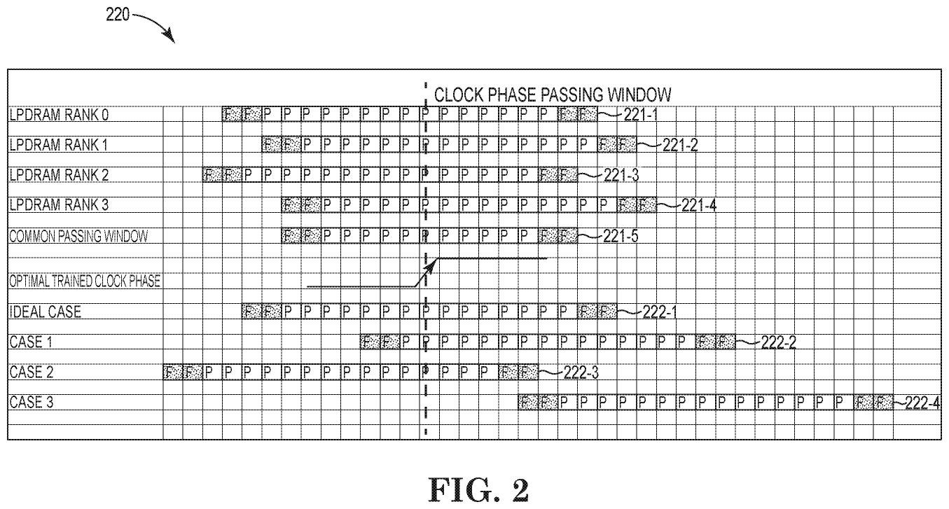

FIG. 2 is a timing diagram 220 of a number of clock phase passing windows 221-1, 221-2, 221-3, 221-4, 221-5, 222-1, 222-2, 222-3, 222-4 in accordance with some embodiments of the present disclosure. The clock phase passing windows 221-1, 221-2, 221-3, 221-4, 221-5 can be referred to as clock phase passing windows 221. The clock phase passing windows 222-1, 222-2, 222-3, 222-4 can be referred to a clock phase passing windows 222.

The clock phase passing windows 221 can correspond to a plurality of ranks of memory devices (e.g., LPDRAM). For example, the clock phase passing window 221-1 can correspond to a first rank (e.g., Rank 0) of memory devices. The clock phase passing window 221-2 can correspond to a second rank (e.g., Rank 1) of memory devices. The clock phase passing window 221-3 can correspond to a third rank (e.g., Rank 2) of the memory devices. The clock phase passing window 221-4 can correspond to a fourth rank (e.g., Rank 3) of the memory device. The clock phase passing window 221-5 can correspond to common clock phase passing window. The clock phase passing window 221-5 can be common to each of the ranks. The CA signals received by the memory devices during the clock phase passing window 221-5 can be timed appropriately such that a MUX can distribute data to the corresponding memory devices.

The clock phase passing windows 222 can correspond to example MUX circuitry. For example, each of the clock phase passing windows 222-2, 222-3, 222-4 can correspond to possible MUX circuitry. For instance, a first possible MUX circuitry (e.g., case 1) can have a clock phase passing window 222-2. A second possible MUX circuitry (e.g., case 2) can have a clock phase passing window 222-3. A third possible MUX circuitry (e.g., case 3) can have a clock phase passing window 222-4. The first case, the second case, and the third case can describe the clock phase passing windows 222 that differ based on attributes of the MUX circuitry. For instance, a first MUX circuitry can have the clock phase passing window 222-2 while a second MUX circuitry has the clock phase passing window 222-3. The clock phase passing window 222-1 can be an ideal clock phase passing window that corresponds to the clock phase passing window 221-5. The clock phase passing window 222-1 can be determined based on the clock phase passing window 221-5.

The clock phase passing window 222-1 can be determined to align with the clock phase passing window 221-5. Aligning the clock phase passing window 222-1 to the clock phase passing window 221-5 can allow for a MUX circuitry to provide data signals to the memory device and for the memory devices to receive the data signal. The clock phase passing window 222-1 can be aligned with the clock phase passing window 221-5 if the clock phase passing window 222-1 and the clock phase passing window 221-5 share a common phase and the common phase is centered in the clock phase passing windows 222-1, 221-5.

Each of the MUX circuitry that have the clock phase passing windows 222-2, 222-3, 222-4 can modify a received clock signals to align the clock phase passing windows 222-2, 222-3, 222-4 with the clock phase passing window 222-1. For example, a clock signal received by the first MUX circuitry can be slowed down to align the clock phase passing window 222-2 with the clock phase passing window 222-1. The clock signal received by the second MUX circuitry can be sped up to align the clock phase passing window 222-3 with the clock phase passing window 222-1. The clock signal received by the third MUX circuitry can be slowed down to align the clock phase passing window 222-4 with the clock phase passing window 222-1. The clock phase passing window 222-4 can be aligned with the clock phase passing window 222-1 even though the clock domains of the third MUX circuitry and some of the memory devices are asynchronous. The examples described herein describe the hardware and process changes implemented in the MUX circuitry that allow the clock phase passing windows 222-2, 222-3 222-4 to be aligned with the clock phase passing window 222-1.

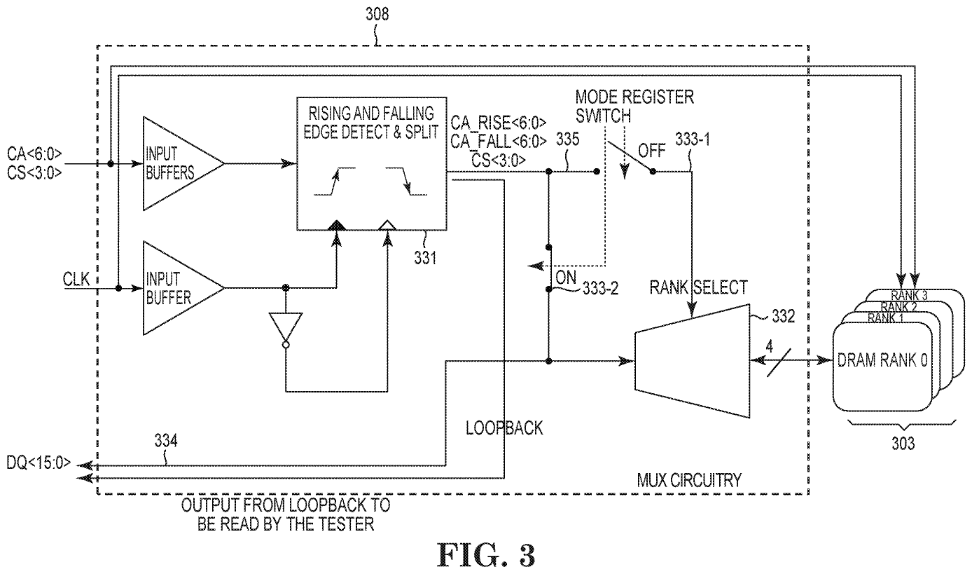

FIG. 3 is a block diagram corresponding to MUX circuitry 308 in accordance with some embodiments of the present disclosure. The MUX circuitry 308 is analogous to the MUX circuitry 108 of FIG. 1. The MUX circuitry 308 can include a rising and falling edge detector and split circuitry 331 which can also be referred to as RFEDS circuitry 331. The MUX circuitry 308 can also include a MUX 332, switches 333-1, 333-2, data (DQ) lines 334, CA lines 335 (e.g., CA lines and CS lines). FIG. 3 also shows the memory devices 303 which are analogous to the memory devices 103 of FIG. 1.

The output of the input buffer corresponding to the clock signals (e.g., CLK) can be used to generate both rising edge clock signals and falling edge clock signals internally. The falling edge clock is an inverted version of the rising edge clock. The falling edge clock can also be known as CLK180 which represents the original clock delayed by 180 degrees. A NOT gate can be used to generate the falling edge clock. The NOT gate can couple the output of the buffer corresponding to the clock signals to the RFEDS circuitry 331.

The examples described herein can be performed during manufacturing testing of the memory system. For example, prior to deployment of the memory system for use, a testing system can perform training using the CA signals and the clock signals received by the memory devices 303 to identify a common clock phase passing window of the memory devices 303. The common clock phase passing window of the memory devices 303 can correspond to the clock phase passing window 221-5 of FIG. 2. The common clock phase passing window can also be referred to as an optimized clock phase passing window (e.g., the common clock phase passing window of the memory devices 303).

The testing system can perform CLK-to-CA training. The testing system can perform CLK-to-CA training by enabling a loopback function of the MUX circuitry 308. For example, the testing system can provide a plurality of signals that can be stored in mode registers of the memory system and/or the MUX circuitry 308. Responsive to storing the plurality of signals in the mode registers a loopback function of the MUX circuitry 308 can be activated. For example, the MUX circuitry 308 can be placed in a test mode or a mission mode based on the plurality of signals. The test mode of the MUX circuitry 308 can allow signals provided by the RFEDS circuitry 331 to be provided to the testing system via the DQ lines 334. The mission mode of the MUX circuitry 308 can allow CA and CS signals to be provided to the MUX 332 and can allow the MUX 332 to distribute data signals received via the DQ lines 334 to the corresponding memory devices 303.

The signals provided by the RFEDS circuitry 331 can be routed to the testing system by disabling the MUX 332 and by routing signals from the CA lines 335 to the DQ lines 334. In various examples, the RFEDS circuitry 331, the CA lines 335, the switches 333-1, 333-2, and/or the DQ lines 334 can be referred to as loopback circuitry when the memory system and/or the MUX circuitry 308 are in a test mode. The MUX 332 can be disabled and the signals from the CA lines 335 can be routed to the DQ lines 334 utilizing the switches 333-1, 333-2. The switches 333-1, 333-2 can be referred to as switches 333. The plurality of values stored in the mode register can be used to set the MUX circuitry 308 to a test mode and to set the switch 333-1 such that the switch 333-1 decouples the MUX 332 from the CA lines 335 (e.g., The switch 331-1 is off as shown in FIG. 3). Turning the switch 333-1 off can result in the switch 333-1 disconnecting the CA lines 335 from the MUX 332. The switch 333-1 can be turned on to connect the CA lines 335 to the MUX 332 if the MUX circuitry 308 is in a mission mode.

If the MUX circuitry 308 is in a test mode, the switch 333-2 can be turned on. If the MUX circuitry 308 is in the mission mode, the switch 333-2 can be turned off. The switch 333-1 and the switch 333-2 can have an inverse relationship. For example, the switch 333-1 can be turned on when the switch 333-2 is turned off and the switch 333-1 can be turned off when the switch 333-2 is turned on. Turning the switch 333-2 on can cause the CA lines 335 to be coupled to the DQ lines 334. Coupling the CA lines 335 to the DQ lines 334 enables the routing of the signals provided by the RFEDS circuitry 331 to the testing system. For example, a decoded CA rise (e.g., CA_rise) signal and a decoded CA fall (e.g., CA_fall) signal can be routed to the testing system. As used herein, the CA rise signals and the CA fall signals are internal signals that are generated from the CLK rising edge and the CLK falling edge, respectively. The CA rising signals and the CA falling signals can be considered de-serialized CA signals after a 1:2 DEMUX, which runs at half speed of the original CA signals.

Each of the CA rise signals and CA fall signals can be routed to the testing system via a different one of the DQ lines 334. For instance, the CA rise and the CA fall signals can each be comprised of 7 bits (e.g., <6:0>). Given that the DQ lines 334 include 16 lines, each of the bits of the CA rise and the CA fall signals can be provided to the testing system via a separate line of the DQ lines 334.

The testing system can capture the signals (e.g., CA rise signals and the CA fall signals) provided by the RFEDS circuitry 331. Based on the signals (e.g., CA rise signals and the CA fall signals) received by the testing system, the testing system can determine an optimal position for the clock signals to center the clock signals to the common clock phase passing window of the memory devices 303. The testing system can determine adjustments to the clock phase passing window of the MUX circuitry 308 based on the optimal position for the clock signals. The adjustments can be referred to as timing constraints. The testing system can determine the adjustments that are to be implemented on the clock signals received by the MUX circuitry 308 to align the clock phase passing window of the MUX circuitry 308 to the common clock phase passing window of the memory devices 303.

Once the testing system determined the adjustments that are needed to the clock signals, the testing system can program the MUX circuitry 308 utilizing the adjustment (e.g., values representing the adjustments).

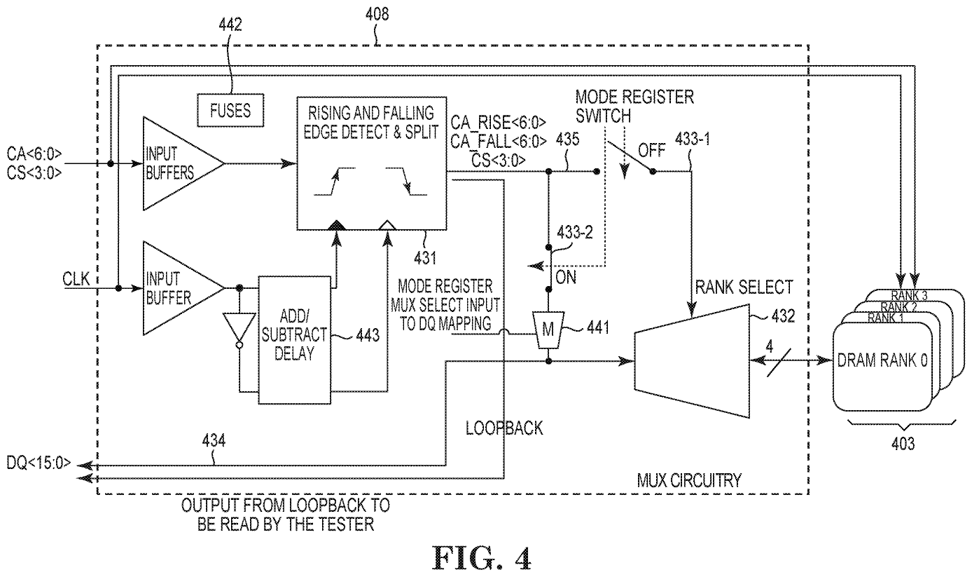

FIG. 4 is a block diagram corresponding to MUX circuitry 408 in accordance with some embodiments of the present disclosure. The MUX circuitry 408 is analogous to the MUX circuitry 108 of FIG. 1 and the MUX circuitry 308 of FIG. 3. The MUX circuitry 408 can include a RFEDS circuitry 431. The MUX circuitry 408 can also include a MUX 432, switches 433-1, 433-2, DQ lines 434, CA lines 435 (e.g., CA lines and CS lines), a MUX 441, fuses 442, and delay circuitry 443 (e.g., add/subtract delay). FIG. 4 also shows the memory devices 403 which are analogous to the memory devices 103 of FIG. 1 and the memory devices 303 of FIG.

### 3.

The MUX circuitry 408 can receive the CA signals (e.g., CA<6:0>), CS signals (e.g., CS<3:0>), and clock signals (e.g., Clk), among other signals. The output of the input buffer corresponding to the clock signals can be used to generate both rising edge clock signals and falling edge clock signals internally. The falling edge clock is an inverted version of the rising edge clock. The falling edge clock can also be known as CLK180 which represents the original clock delayed by 180 degrees. A NOT gate can be used to generate the falling edge clock. The NOT gate can couple the output of the buffer corresponding to the clock signals to the delay circuitry 443.

The MUX circuitry 408 can provide the CA signals, the CS signals, and/or the clock signals to the RFEDS circuitry 431. The RFEDS circuitry 431 can utilize the CA signals, the CS signals, and the clock signals to generate the CA rise (e.g., CA_rise<6:0>) signals, CA fall (e.g., CA_fall<6:0>) signals, and the CS (e.g., CS<3:0>) signals. The RFEDS circuitry 431 can provide the CS signals as an output via the CA lines 435. The CA rise signals, the CA fall signals, and/or the CS signals can be provided to the training system to determine adjustments for the clock signals.

For example, the CA rise signals, the CA fall signals, and/or the CS signals can be routed to the DQ lines 434 instead of the MUX 432. If the MUX circuitry 408 is in a mission mode, the CA rise signals, the CA fall signals, and/or the CS signals can be provided to the MUX 432 via the switch 433-1. If the MUX circuitry 408 is in a test mode, the CA rise signals, the CA fall signals, and/or the CS signals can be provided to the DQ lines via the switch 433-2 and the MUX 441.

The MUX 441 can map CA rise signals, CA fall signals, and/or the CS signals to the DQ lines 434. The mapping between CA rise signals, CA fall signals, and/or the CS signals and the DQ lines 434 can allow a testing system to receive the CA rise signals, the CA fall signals, and/or the CS signals in an expected manner. For example, the MUX 441 can map a first bit of the CA rise signals to a first DQ line, a second bit of the CA rise signals to a third DQ line, and a third bit of the CA rise signals to a second DQ line, among other possible mappings of bits of the CA rise signals to DQ lines 434. The DQ lines 434 can provide the CA rise signals, the CA fall signals, and/or the CS signals to an interface of the memory system. The testing system can receive the CA rise signals, the CA fall signals, and/or the CS signals via the interface that couples the testing system to the memory system.

The testing system can determine the adjustments for the clock signals based on the CA rise signals, the CA fall signals, and/or the CS signals. For example, the testing system can utilize the CA rise signals, the CA fall signals, and/or the CS signals to generate a clock phase passing window for the MUX 432. The testing system can compare the clock phase passing window of the MUX 432 and a common clock phase passing window of the memory devices 403 to determine an adjustment to the clock signals that can be used to align the clock phase passing window of the MUX 432 to the common clock phase passing window of the memory device 403.

The testing system can cause the adjustments to be programed in the memory system. For example, the testing system can provide a command to the memory system to cause the memory system to store the adjustments. The memory system can store the adjustments in the fuses 442. For example, the testing system, the memory system, and/or the MUX circuitry 408 can program the fuses 442 to store the adjustments. Programing the fuses 442 can include blowing a portion of the fuses 442 such that the state of the fuses 442 represent the data comprising the adjustments. Although the fuses 442 are shown as being separate from the RFEDS circuitry 431 and internal to the MUX circuitry 408, the fuses 442 can be implemented internal to the RFEDS circuitry 431.

In some examples, the fuses 442 can be implemented in the memory devices 403. For example, the testing system can provide the adjustments to the memory devices 403. The memory devices 403 can program fuses internal to the memory devices 403 utilizing the data representing the adjustments.

Data received after the adjustments have been programmed into the fuses 442 can be distributed by the MUX 432 utilizing the adjusted CA signals, CS signals, and clock signals. The CA signals, CS signals, and clock signals can be adjusted using the adjustments stored in the fuses 442. For example, the adjustments stored in the fuses 442 can be provided to the delay circuitry 443. The delay circuitry 443 can include hardware and/or firmware for adjusting a timing of the clock signals received by the MUX circuitry 408. The adjustments can be read from the fuses 442. The fuses 442 can provide the data representing the adjustments to the delay circuitry 443. For example, a host can cause the adjustments to be provided from the fuses 442 to the delay circuitry 443 at run time. The host can cause the fuses 442 to provide the adjustments to the delay circuitry 443 regardless of whether the fuses 442 are external to the RFEDS circuitry 431 but internal to the MUX circuitry 408, whether the fuses 442 are internal to the RFEDS circuitry 431, or the fuses 442 are internal to the memory devices 403.

The delay circuitry 443 can store the adjustments and can use the adjustments to modify the clock signals. For example, the delay circuitry 443 can cause the clock signals to be sped up, slowed down, or remain unaltered. For instance, the delay circuitry can add a delay of subtract a delay from the clock signals.

The RFEDS circuitry 431 can utilize the clock signals that may or may not have been altered to determine when to provide the CA rise signals, the CA fall signals, and/or the CS signals. The host system can place the memory system and/or the MUX circuitry 408 in a mission mode. Responsive to being in a mission mode, the switch 433-1 can be turned on to cause the CA rise signals, the CA fall signals, and/or the CS signals to be provided to the MUX 432. Responsive to the MUX circuitry 408 and/or the memory system being in the mission mode, the switch 433-2 can be turned off to disconnect the CA lines 435 from the DQ lines 434.

The CA rise signals, the CA fall signals, and/or the CS signals can be utilized by the MUX 432 to determine when to provide data, provided via the DQ lines 434, to one or more memory devices 403 in a corresponding rank. The CA rise signals, the CA fall signals, the CS signals, and/or the modified clock signals can be utilized to align the clock phase passing window of the MUX circuitry 308 with the common clock phase passing window of the memory devices 403.

In various examples, the MUX circuitry 408 and/or the memory system can be placed in a mission mode from a test mode at the conclusion of the testing of the memory system and/or the MUX system by the test system. The MUX circuitry 408 and/or the memory system can also be placed in the mission mode from the test mode by a host system once the MUX circuitry 408 and/or the memory system begin run time execution.

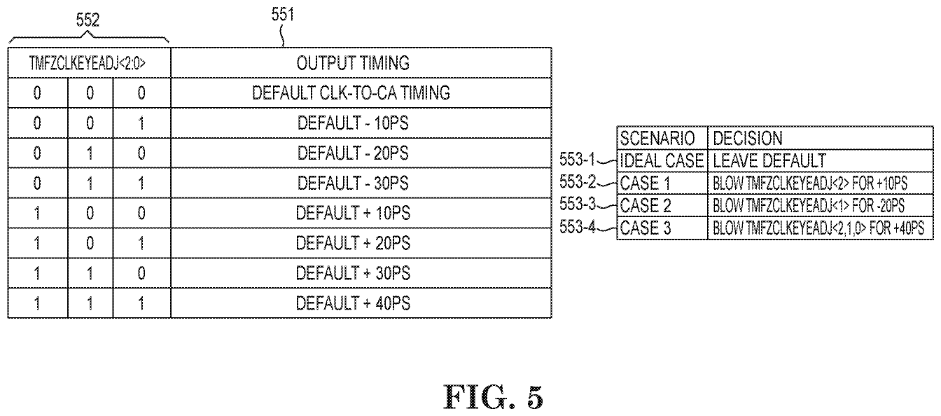

The delay circuitry 443 can include a number of paths that can provide the clock signals to the RFEDS circuitry 431. Each of the paths can provide the clock signals to the RFEDS circuitry 431 in more or less time than the other paths. The data provided by the fuses 442 can be used to select a path from the plurality of paths of the delay circuitry 443. FIG. 5 provides an example of how the adjustments can be programmed into the fuses 442.

FIG. 5 is a block diagram corresponding to fuse values 552 in accordance with some embodiments of the present disclosure. The adjustment data stored in the fuses (e.g., fuses 442 of FIG. 4) can also be referred to as fuse values 552. The adjustment data and/or the fuse values 552 can also be referred to as timing constraints.

Each of the fuse values 552 can be associated with a delay value 551. The delay values 551 can include a default clock to CA (e.g., CLK-to-CA) timing. The delay values 551 include −10 picoseconds (ps), −20 ps, −30 ps, +10 ps, +20 ps, +30 ps, and +40 ps. The examples provided of delay values 551 are illustrative and are not intended to be limiting. Other delay values 551 can be utilized in the examples provided herein.

A first fuse value can be a 000 bit value. A second fuse value can be a 001 bit value. A third fuse value can be a 010 bit value. A fourth fuse value can be a 011 bit value. A fifth fuse value can be a 100 bit value. A sixth fuse value can be a 100 bit value. A seventh fuse value can be a 101 bit value. An eighth fuse value can be a 110 bit value. A ninth fuse value can be a 111 bit value. Each of the bit vales 552 can also correspond to a different delay path of the delay circuitry 443 of FIG. 4.

In an ideal case 553-1 where the clock phase passing window of the MUX circuitry aligns with the common clock phase passing window of the memory devices, the first fuse value can be utilized to leave the clock signals unadjusted (e.g., leave default). In a first case 553-2 where the clock phase passing window of the MUX circuitry is slower than the common clock phase passing window of the memory devises the fifth fuse value can be utilized. In a second case 553-3 where the clock phase passing window of the MUX circuitry is faster than the common clock phase passing window of the memory devises the third fuse value can be utilized. In a third case 553-4 where the clock phase passing window of the MUX circuitry is faster than the common clock phase passing window of the memory device the eighth fuse value can be utilized.

The examples described in FIG. 5 include fuse values 552 that are comprised of three bits. However, more or less than three bits can be utilized to encode the fuse values 552. The number of bits used in the fuse values 552 can be the number of fuses used to store the fuse values 552. For example, if four bits are used to represent the fuse values 552, then four fuses can be utilized to the store the fuse values 552.

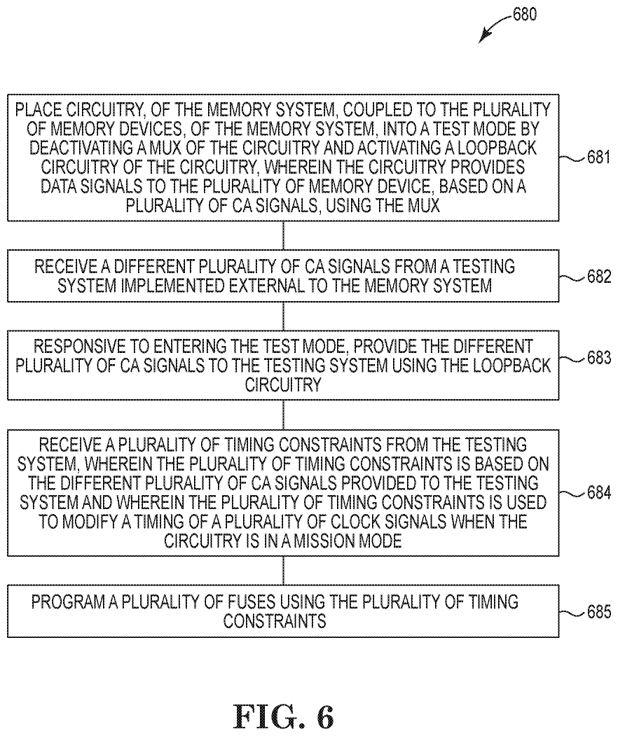

FIG. 6 is a flow diagram corresponding to a method 680 for configuring a clock control module in accordance with some embodiments of the present disclosure. The method 681 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 680 is performed by the MUX circuitry 108 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 681, circuitry (e.g., the MUX circuitry 108 of FIG. 1), of the memory system (e.g., the memory system 102 of FIG. 1) coupled to the plurality of memory devices (e.g., the memory devices 303 of FIG. 3), of the memory system, can be placed into a test mode. The circuitry can be placed in a test mode by deactivating a MUX (e.g., the MUX 332 of FIG. 3) of the circuitry and activating a loopback circuitry of the circuitry. The circuitry can provide data signals to the plurality of memory device, based on a plurality of CA signals, a plurality of CS signals, and/or clock signals, using the MUX.

At 682, a different plurality of CA signals can be received from a testing system implemented external to the memory system. The testing system can be used at manufacturing time and not at run time. The testing system can provide the different plurality of CA signals to determine adjustments needed to align a clock phase passing window of the circuitry and/or the MUX with a common clock phase passing window of the plurality of memory devices.

At 683, responsive to entering the test mode, the different plurality of CA signals can be provided to the testing system using the loopback circuitry. The loopback circuitry can include one or more switches. The one or more switches can rout the different plurality of CA signals from a plurality of CA lines to a plurality of DQ lines. The different plurality of CA signals can be provided to the testing system via the DQ lines.

At 684, a plurality of timing constraints can be received from the testing system. The plurality of timing constraints can be based on the different plurality of CA signals provided to the testing system. The plurality of timing constraints is used to modify a timing of a plurality of clock signals when the circuitry is in a mission mode. The timing constraints can be used to program a plurality of fuses such that the timing constraints can be referred to as fuse values (e.g., the fuse values 552 of FIG. 5). At 685, the plurality of fuses can be programmed using the plurality of timing constraints. The plurality of fuses can be part of the circuitry. The plurality of fuses can be implemented externally to the circuitry. For example, the plurality of fuses can be implemented in the plurality of memory devices. For instance, the plurality of fuses of the memory device can be fuses used to activate redundant rows of the memory devices. Regardless of where the plurality of fuses is implemented, the plurality of fuses can be programmed using the timing constraints.

Responsive to determining that the circuitry is in the mission mode, the plurality of timing constraints stored in the plurality of fuses can be accessed from the plurality of fuses. The plurality of timing constraints can be provided from the plurality of fuses to delay circuitry of the circuitry. The plurality of timing constraints can be stored in the delay circuitry. For instance, the plurality of timing constraints can be stored in registers of the delay circuitry and/or different memory of the delay circuitry.

The plurality of timing constraints stored in the delay circuitry can be accessed. The plurality of timing constraints can be used to modify the timing of the plurality of clock signals when the circuitry is in the mission mode. The plurality of clock signals that have had their timing modified can be provided to the MUX when the circuitry is in the mission mode.

In various examples, a memory system can comprise a plurality of memory devices and circuitry coupled to the plurality of memory devices. The circuitry can comprise a MUX and loopback circuitry. The MUX can provide data signals to the plurality of memory devices based on a plurality of CA signals and a plurality of CS signals received from a host.

The circuitry can enter a test mode by deactivating the MUX and activating a loopback circuitry. The MUX can be deactivated and the loopback circuitry can be activated using a number of switches (e.g., the switches 333-1, 333-2 of FIG. 3). The circuitry can receive a different plurality of CA signals. Responsive to entering the test mode, the circuitry can provide the different plurality of CA signals to a testing system implemented external to the memory system using the loopback circuitry. The circuitry can receive a plurality of timing constraints from the testing system. The plurality of timing constraints can be based on the different plurality of CA signals provided to the testing system. The plurality of timing constraints can be used to modify a timing of a plurality of clock signals when the circuitry is in a mission mode.

The circuitry can, responsive to receipt of the plurality of timing constraints, enter the mission mode. The circuitry can enter the test mode during manufacturing package testing. Manufacturing package testing can describe a testing of the memory system at manufacturing time.

The circuitry can include delay circuitry. The delay circuitry can receive the plurality of timing constraints from the testing system. The delay circuitry is further configured to modify the timing of the plurality of clock signals using the plurality of timing constraints.

The loopback circuitry can include DQ lines (e.g., data lines). The DQ lines can provide the data signals to the testing system, for example. The loopback circuitry can couple a RFEDS circuitry to the data lines. The loopback circuitry can comprise a first switch configured to couple the RFEDS circuitry to the data lines based on the circuitry being in the test mode. The first switch can also refrain from coupling the RFEDS circuitry to the data lines based on the circuitry being in a mission mode. A second switch can also deactivate the MUX based on the circuitry being in the test mode.

In a number of examples, an apparatus can comprise a plurality of memory devices and circuitry coupled to the plurality of memory devices. The circuitry can comprise a MUX and a plurality of fuses. The circuitry can receive a plurality of CA signals from a host. The circuitry can access a plurality of timing constraints from the plurality of fusses. The plurality of timing constraints can be stored in the plurality of fuses. The circuitry can modify a timing of a plurality of clock signals using the plurality of timing constraints. The circuitry can provide the plurality of CA signals to the MUX using the plurality of clock signals. The MUX can provide data signals received from the host to one or more of the plurality of memory devices based on the plurality of CA signals. The circuitry can determine that the circuitry is in a mission mode. The MUX can, responsive to determining that the circuitry is in the mission mode, provide the data signals received from the host to the one or more of the plurality of memory devices based on the plurality of CA signals.

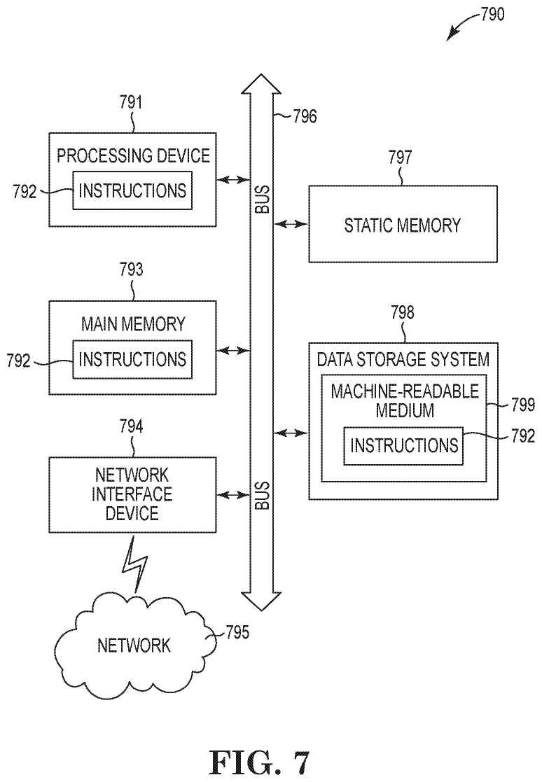

FIG. 7 is a block diagram of an example computer system 700 in which embodiments of the present disclosure may operate. For example, FIG. 7 illustrates an example machine of a computer system 700 within which a set of instructions, for causing the machine to perform any one or more of the methodologies discussed herein, can be executed. In some embodiments, the computer system 700 can correspond to a host system and/or a tester system (e.g., the host system 101 and/or the tester system 101 of FIG. 1) that includes, is coupled to, or utilizes a memory system (e.g., the memory system 102 of FIG. 1) or can be used to perform the operations of a controller (e.g., to execute an operating system to perform operations corresponding to the MUX circuitry 108 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage system 718, which communicate with each other via a bus 730.

The processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory system 102 of FIG. 1.

In one embodiment, the instructions 726 include instructions to implement functionality corresponding to a MUX circuitry (e.g., the MUX circuitry 108 of FIG. 1). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory system, comprising:
a plurality of memory devices;
circuitry coupled to the plurality of memory devices and comprising a multiplexor (MUX) and loopback circuitry;
wherein the MUX is configured to provide data signals to the plurality of memory devices based on a plurality of command and address (CA) signals received from a host; and
wherein the circuitry is configured to:
enter a test mode by deactivating the MUX and activating a loopback circuitry;
receive a different plurality of CA signals;
responsive to entering the test mode, provide the different plurality of CA signals to a testing system implemented external to the memory system using the loopback circuitry; and
receive a plurality of timing constraints from the testing system, wherein the plurality of timing constraints is based on the different plurality of CA signals provided to the testing system and wherein the plurality of timing constraints modify a timing of a plurality of clock signals when the circuitry is in a mission mode.

2. The memory system of claim 1, wherein the circuitry is further configured to, responsive to receipt of the plurality of timing constraints, enter the mission mode.

3. The memory system of claim 1, wherein the circuitry is configured to enter the test mode during manufacturing package testing.

4. The memory system of claim 1, wherein the circuitry further comprises delay circuitry configured to receive the plurality of timing constraints.

5. The memory system of claim 4, wherein the delay circuitry is further configured to modify the timing of the plurality of clock signals using the plurality of timing constraints.

6. The memory system of claim 1, wherein loopback circuitry includes data lines configured to provide the data signals.

7. The memory system of claim 6, wherein the loopback circuitry couples a rising and falling edge detection and split circuitry to the data lines.

8. The memory system of claim 7, wherein loopback circuitry further comprises a switch configured to couple the rising and falling edge detection and split circuitry to the data lines based on the circuitry being in the test mode.

9. The memory system of claim 6, wherein the loopback circuitry further comprises a switch configured to refrain from coupling the rising and falling edge detection and split circuitry to the data lines based on the circuitry being in a mission mode.

10. The memory system of claim 1, wherein the circuitry further comprises a switch configured to deactivate the MUX based on the circuitry being in the test mode.

11. A method, comprising:
placing circuitry, of the memory system, coupled to the plurality of memory devices, of the memory system, into a test mode by deactivating a multiplexor (MUX) of the circuitry and activating a loopback circuitry of the circuitry, wherein the circuitry provides data signals to the plurality of memory device, based on a plurality of command and address (CA) signals, using the MUX;
receiving a different plurality of CA signals from a testing system implemented external to the memory system;
responsive to entering the test mode, providing the different plurality of CA signals to the testing system using the loopback circuitry;
receiving a plurality of timing constraints from the testing system, wherein the plurality of timing constraints is based on the different plurality of CA signals provided to the testing system and wherein the plurality of timing constraints is used to modify a timing of a plurality of clock signals when the circuitry is in a mission mode; and
programming a plurality of fuses using the plurality of timing constraints.

12. The method of claim 11, further comprising programming the plurality of fuses of the circuitry using the plurality of timing constraints.

13. The method of claim 11, further comprising programming the plurality of fuses implemented externally to the circuitry using the plurality of timing constraints.

14. The method of claim 11, further comprising programming the plurality of fuses implemented in the plurality of memory devices using the plurality of timing constraints.

15. The method of claim 11, further comprising responsive to determining that the circuitry is in the mission mode, accessing the plurality of timing constraints stored in the plurality of fuses.

16. The method of claim 15, further comprising:
providing the plurality of timing constraints to delay circuitry of the circuitry; and
storing the plurality of timing constraints in the delay circuitry of the circuitry.

17. The method of claim 15, further comprising:
accessing the plurality of timing constraints stored in the delay circuitry;
modifying the timing of the plurality of clock signals when the circuitry is in the mission mode; and
providing the plurality of clock signals that have had their timing modified to the MUX when the circuitry is in the mission mode.

18. An apparatus comprising:
a plurality of memory devices;
circuitry coupled to the plurality of memory devices and comprising a multiplexor (MUX) and a plurality of fuses;
wherein the circuitry is configured to:
receive a plurality of control and address (CA) signals from a host;
access a plurality of timing constraints from the plurality of fuses;
modify a timing of a plurality of clock signals using the plurality of timing constraints;
provide the plurality of CA signals to the MUX using the clock signals; and
wherein the MUX is configured to provide data signals received from the host to one or more of the plurality of memory devices based on the plurality of CA signals.

19. The apparatus of claim 18, wherein the circuitry is further configured to determine that the circuitry is in a mission mode.

20. The apparatus of claim 19, wherein the MUX is further configured to, responsive to determining that the circuitry is in the mission mode, provide the data signals received from the host to the one or more of the plurality of memory devices based on the plurality of CA signals.
